(19) United States
(12) Patent Application Publication
(10) Pub. No.: US 2021/0146421 A1
(43) Pub. Date: May 20, 2021

(54) RESTRAINT DEVICE FOR VEHICULAR FRAME STRAIGHTENING SYSTEMS

(71) Applicant: Robert A. Davis, Titusville, FL (US)

(72) Inventor: Robert A. Davis, Titusville, FL (US)

(21) Appl. No.: 16/687,160

(22) Filed: Nov. 18, 2019

(51) Int. Cl. B21D 1/14; B21D 3/12

(52) U.S. Cl. CPC B21D 1/14; F16G 15/00; B21D 3/12

(57) ABSTRACT

A restraint device for use with a vehicular straightening system includes an elongated tether that is connected to a restraining net along a first end, and an anchor connector along a second end. The anchor connector includes functionality for engaging the platform of the straightening system, and the restraining net includes a shape and size that is suitable for encompassing the fastening mechanism of the straightening system. A plurality of net connectors secure the restraining net about the fastening mechanism, and each of the tether, the restraining net and the connectors are constructed from materials having a high tensile strength for resisting a recoil force associated with a breakage of the fastening mechanism when a pulling force is applied thereon.

### TECHNICAL FIELD

The present invention relates generally to motor vehicle frame straightening equipment, and more particularly to a restraint device for a frame straightening system.

### BACKGROUND

The statements in this section merely provide background information related to the present disclosure and may not constitute prior art.

There are many known types of systems and devices for straightening automobile bodies after collisions. As shown at Background FIG. 1, such systems typically include a platform 2 or other structure for securing a vehicle 1 in place. An elongated chain 3 having a clip, clevis or other fastening mechanism 4 along one end is then physically mated with a portion of the vehicle frame, and the second end of the chain is connected to a hydraulic pulling machine 5. The force (arrow a) imparted by the pulling machine through the chain and clip can sometimes be in excess of 10-15 tons, and functions to pull the body or frame of the vehicle back to a normal shape.

Although these devices work well for their intended purpose, it is not uncommon for the clip to break or otherwise become separated from the vehicle during the straightening procedure. When this occurs, the sudden loss of resistance causes the chain 3 and clip 4 to recoil/snap toward the pulling machine causing damage to the same. Moreover, at certain times during the straightening process, it is necessary for a person to visually inspect the progress to make sure the frame is not pulled too far. Although most shops employ strict safety protocols that forbid workers from being near the equipment during operation, several serious injuries and deaths have occurred.

Accordingly, it would be beneficial to provide a restraint device that can stop or reduce the recoil force of a chain during operation of a frame straightening system.

### SUMMARY OF THE INVENTION

The present invention is directed to a restraint device for use with a vehicular straightening system. One embodiment of the present invention can include an elongated tether that is connected to a restraining net along a first end, and an anchor connector along a second end. The anchor connector can include functionality for engaging the platform of the straightening system, and the restraining net can include a shape and size that is suitable for encompassing the fastening mechanism of the straightening system.

One embodiment of the present invention can include a plurality of net connectors for securing the restraining net about the fastening mechanism, and each of the tether, the restraining net and the connectors can be constructed from materials having a high tensile strength for resisting a recoil force associated with a breakage of the fastening mechanism when a pulling force is applied thereon.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a side view of a vehicular straightening system in accordance with background art.

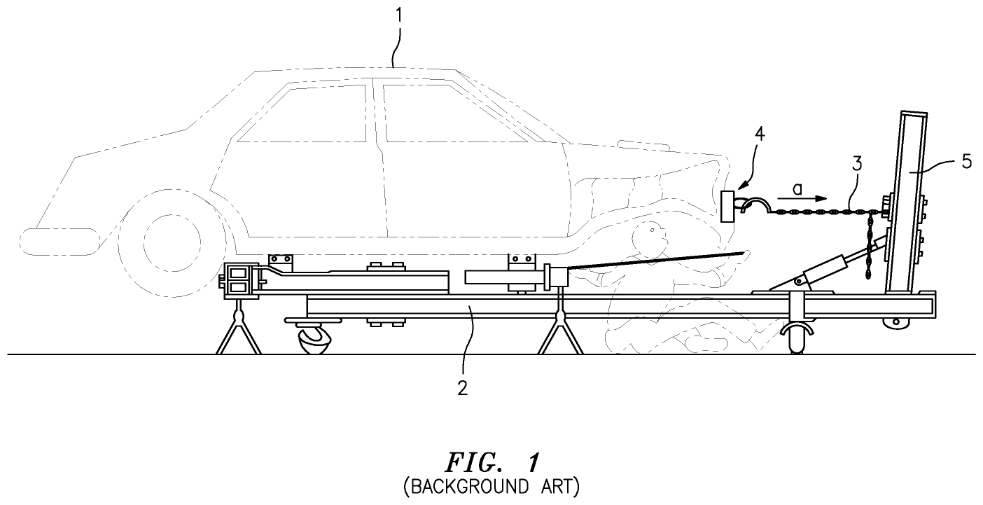

FIG. 2 is a top view of a restraining device for a vehicular straightening system in accordance with one embodiment of the invention.

FIG. 3 is a side view of the restraining device for a vehicular straightening system in operation, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

### Definitions

As described herein, the term “removably secured,” and derivatives thereof shall be used to describe a situation wherein two or more objects are joined together in a non-permanent manner so as to allow the same objects to be repeatedly joined and separated.

As described herein, the term “connector” can include any number of different components that can repeatedly join two items together in a removable manner. Several nonlimiting examples of connectors for use herein include, but are not limited to opposing strips of hook and loop material (i.e. Velcro®), attractively-oriented magnetic elements, flexible strips of interlocking projections with a slider (i.e., zipper), locking tethers such as zip ties, buckles such as side release buckles, and compression fittings such as T-handle rubber draw latches, hooks, snaps, buttons, clamps, clasps, locks, brackets, and other such fasteners, for example.

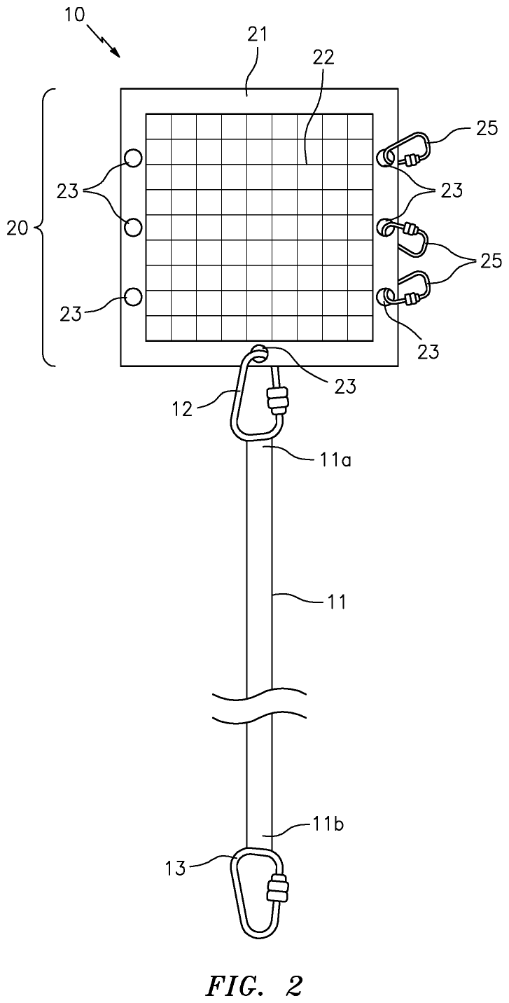

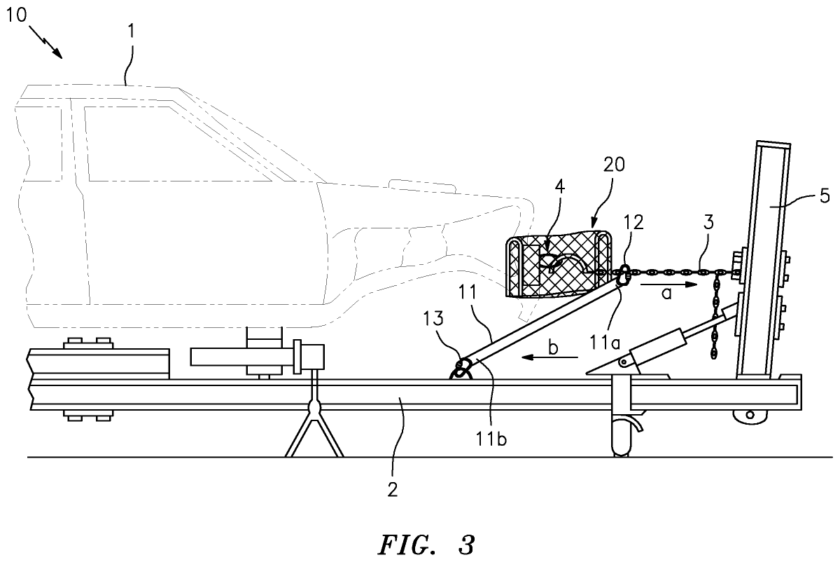

FIGS. 2 and 3 illustrate one embodiment of a restraint device 10 for use with a vehicle straightening system and that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 2.

As shown in FIG. 2, the device 10 can include, essentially, an elongated tether 11 having a restraining net 20 along one end.

The tether 11 can function to prevent movement of the restraining net during device operation, and can include, comprise or consist of an elongated generally malleable member having a looped first end 11a, and a looped second end 11b. In the preferred embodiment, the tether can be constructed from polypropylene or nylon straps having a vertical tensile strength/breaking strength of at least 3,200 pounds. Of course, any number of other materials and/or tensile strengths are also contemplated.

In one embodiment, a chain connector 12 and anchor connector 13 can be positioned within the looped first and second ends 11a and 11b, respectively. These connectors can preferably comprise metallic quick-connect carabiners, for example, which can be used to secure the tether 11 to the restraining net 20 and the straightening platform 4, respectively. Each of the connectors 12 and 13 including a breaking strength that is equal to or greater than the breaking strength of the tether 11.

Although described as having a looped first end 11a that is removably connected to the restraining net via a connector 12, other embodiments are also contemplated. To this end, the first end of the tether 11a can be permanently secured to the restraining net 20 in accordance with known manufacturing methods such as reinforced stitching, for example, or can be constructed from the same material as the net border 21 so as to be formed as a single uninterrupted device. When so constructed, the chain connector 12 can be positioned within one of the below described apertures and can function in the manner described hereinafter.

Likewise, the anchor connector 13 can include any number of other types of fittings capable of securing the second end of the tether to any number of different structures that are located generally opposite to the pulling machine 5 of the straightening system.

The restraining net 20 is designed to be positioned about the fastening mechanism 4 of the straightening system in a manner that still permits workers to see the mechanism 4 during system operation. In one embodiment, the restraining net 20 can include a generally square or rectangular-shaped member having an outer border 21 for supporting a plurality of interwoven strands 22.

In the preferred embodiment, the border 21 and strands 22 can be constructed from malleable polypropylene or nylon materials having a vertical tensile strength that is at least half the strength of the tether 11. Of course, any number of other shapes, sizes, construction materials and/or tensile strengths are also contemplated.

In one embodiment, a plurality of grommeted apertures 23 can be positioned along the border 21 of the restraining net. Each of these apertures functioning to receive a net connector 25 such as metallic quick-connect carabiners, for example, having a breaking strength that is equal to or greater than the breaking strength of the net material(s).

In the preferred embodiment, the restraining net 20 can include a length and a width of approximately 14 inches each. Such a dimension being suitable for encompassing the fastening mechanisms employed in most commercially available vehicular straightening systems. Of course, any number of other dimensions are also contemplated.

FIG. 3 illustrates one embodiment of the device 10 in operation with a vehicle straightening system. As shown, the restraining net 20 can be wrapped around the fastening mechanism 4 and connecting chain portion 3 of the system, and the net connectors 25 can be used to secure the net in place. In this regard, the connectors 25 can be clipped through any number of other grommeted openings 23 and/or onto the border 21 or strand 22 material directly.

Next, the chain connector 12 can be positioned through one link of the chain 3 adjacent to the fastening mechanism 4, and the second end of the tether 11b can be positioned in a direction that is generally opposite to the location of the pulling machine 5. At this time, the anchor connector 13 can be secured onto the platform 2 or other structure and the tether can be lightly pulled to remove slack.

Next, the pulling machine 5 can be operated in the conventional manner whereby force (arrow a) is exerted onto the vehicle frame or body through the chain 3 and fastening mechanism 4. During this operation, the presence of the restraining device 10 does not affect normal operation of the system, as the openings formed between the interweaving strands 22 of the restraining net allow workers to view the fastening mechanism 4 at all times.

In the event of an unexpected disconnection or failure of the fastening mechanism 4, the restraining system 10 performs two important functions. First, the tether can function to reduce or eliminate the uncontrolled recoil of the chain associated with a separation or breakage of the fastening mechanism. This is accomplished because the high tensile tether 11 is positioned generally opposite (arrow b) to the pulling machine 5, and the first end 11a is directly connected to the chain via the chain connector 12. As such, if/when the chain recoils or attempts to snap toward the pulling machine, the tether will absorb the force and prevent movement of the same.

Second, because the net 20 is physically wrapped around the chain 3 and fastening mechanism 4, any debris resulting from the breakage can be absorbed by the net, thereby preventing or reducing shrapnel from being discharged throughout the workspace.

Accordingly, the above described restraint device for a vehicular frame straightening system provides an innovative solution to prevent damage associated with component failures that is not rendered obvious by the known art.

As described herein, one or more elements of the device 10 can be secured together utilizing any number of known attachment means. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the terms “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A restraining device, comprising:
an elongated tether having a first end and a second end; and
a restraining net having a plurality of interwoven strands that are surrounded by an outer border,
wherein the restraining net is positioned along the second end of the elongated tether, and wherein the restraining net includes a shape and size that is suitable for encompassing a fastening mechanism of a vehicular straightening system.

2. The device of claim 1, further comprising:
a plurality of apertures that are positioned along the outer border of the restraining net.

3. The device of claim 2, further comprising:
metallic grommets that are positioned within each of the plurality of apertures.

4. The device of claim 2, further comprising:
a plurality of net connectors that are configured to engage at least one of the apertures and another portion of the restraining net to secure the net in a closed position.

5. The device of claim 4, wherein in the closed position, the restraining net is folded about an entirety of the fastening mechanism.

6. The device of claim 1, wherein the restraining net is constructed from a high tensile material and is configured to absorb shrapnel resulting from a breakage of the fastening mechanism.

7. The device of claim 6, wherein the restraining net includes a tensile strength of at least 500 pounds.

8. The device of claim 1, further comprising:
an anchor connector that is positioned along the second end of the elongated tether, said anchor connector including functionality for engaging a platform of a vehicular straightening system.

9. The device of claim 8, wherein the elongated tether is constructed from a high tensile material and is configured to resist a recoil force resulting from a breakage of the fastening mechanism.

10. The device of claim 9, wherein the elongated tether includes a tensile strength of at least 1000 pounds.

11. A method of employing a restraining device on a vehicle straightening system, said method comprising:
providing a restraining device that includes an elongated tether having a first end and a second end, and a restraining net having a plurality of interwoven strands that are surrounded by an outer border;
securing the restraining net about a fastening mechanism of the straightening system;
securing the first end of the elongated tether to a platform member of the straightening system in a first direction;
applying a pulling force onto the fastening mechanism in a second direction via a pulling machine of the straightening system; and
resisting a recoil force of the fastening mechanism via the elongated tether and the restraining net,
wherein the first direction and the second direction are opposite to each other.
